(19) United States
(12) Patent Application Publication
(10) Pub. No.: US 2025/0307349 A1
(43) Pub. Date: Oct. 2, 2025

(54) METHODS AND SYSTEMS FOR ROUNDING OF MULTIPLICATION AND DIVISION OF FIXED-POINT NUMBERS ENCODED IN THE DOMAIN OF FAREY RATIONALS FOR MPC SYSTEMS

(71) Applicant: Algemetric, Inc., Colorado Springs, CO (US)

(72) Inventors: Gaetan Delavignette, Colorado Springs, CO (US); Luke E. Harmon, Colorado Springs, CO (US)

(73) Assignee: Algemetric, Inc., Colorado Springs, CO (US)

(21) Appl. No.: 19/093,106

(22) Filed: Mar. 27, 2025

Related U.S. Application Data
(60) Provisional application No. 63/570,615, filed on Mar. 27, 2024.

(51) Int. Cl. G06F 17/17; G06F 7/487

(52) U.S. Cl. CPC G06F 17/17; G06F 7/487

(57) ABSTRACT

Disclosed are methods and systems to provide a rounding protocol to permit extended use of homomorphic multiplication and division for a Multi-Party Computation (MPC) system, such as Mercury. The various embodiments operate on fixed-point data using the rounding protocol to provide an approximation of the precision of the fixed-point encoded variable operands of the multiplication or division operation. The various embodiments further use a unique uniform random bit protocol to provide a random integer for the rounding protocol.

### CROSS-REFERENCE TO RELATED APPLICATIONS

This application is based upon and claims the benefit of U.S. provisional application Ser. No. 63/570,615, filed Mar. 27, 2024, entitled “Constant-Round Protocols for Secure Fixed-Point Arithmetic with the Farey Rationals,” all of which is also specifically incorporated herein by reference for all that it discloses and teaches.

### BACKGROUND OF THE INVENTION

The advancement of science is possible when knowledge is shared and information is exchanged in a seamless manner. In a world where many businesses rely on information as their main assets, analysis over data is a crucial competitive advantage. Consequently, the amount of data processed and stored will continue to increase, creating a demand for virtualized services. To this end, some applications can be provided as cloud computing resources including Internet of Things (IoT), machine learning, virtual reality (VR) and blockchain. As a result, concerns about custody and privacy of data are on the rise.

Modern concealment/encryption employs mathematical techniques that manipulate positive integers or binary bits. Asymmetric concealment/encryption, such as RSA (Rivest-Shamir-Adleman), relies on number theoretic one-way functions that are predictably difficult to factor and can be made more difficult with an ever-increasing size of the encryption keys. Symmetric encryption, such as DES (Data Encryption Standard) and AES (Advanced Encryption Standard), uses bit manipulations within registers to shuffle the concealed text/cryptotext/ciphertext to increase “diffusion” as well as register-based operations with a shared key to increase “confusion.” Diffusion and confusion are measures for the increase in statistical entropy on the data payload being transmitted. The concepts of diffusion and confusion in encryption are normally attributed as first being identified by Claude Shannon in the 1940s. Diffusion is generally thought of as complicating the mathematical process of generating unencrypted (plain text) data from the encrypted (cryptotext/ciphertext) data, thus, making it difficult to discover the encryption key of the concealment/encryption process by spreading the influence of each piece of the unencrypted (plain) data across several pieces of the concealed/encrypted (cryptotext) data. Consequently, an encryption system that has a high degree of diffusion will typically change several characters of the concealed/encrypted (cryptotext/ciphertext) data for the change of a single character in the unencrypted (plain) data making it difficult for an attacker to identify changes in the unencrypted (plain) data. Confusion is generally thought of as obscuring the relationship between the unencrypted (plain) data and the concealed/encrypted (cryptotext) data. Accordingly, a concealment/encryption system that has a high degree of confusion would entail a process that drastically changes the unencrypted (plain) data into the concealed/encrypted (cryptotext/ciphertext) data in a way that, even when an attacker knows the operation of the concealment/encryption method (such as the public standards of RSA, DES, and/or AES), it is still difficult to deduce the encryption key.

Homomorphic Encryption is a form of encryption that allows computations to be carried out on concealed ciphertext as it is concealed/encrypted without decrypting the ciphertext that generates a concealed/encrypted result which, when decrypted, matches the result of operations performed on the unencrypted plaintext.

The word homomorphism comes from the ancient Greek language: óuóç (homos) meaning “same” and μoρφ\acute{η} (morphe) meaning “form” or “shape.” Homomorphism may have different definitions depending on the field of use. In mathematics, for example, homomorphism may be considered a transformation of a first set into a second set where the relationship between the elements of the first set are preserved in the relationship of the elements of the second set.

For instance, a map between sets and is a homomorphism of into if

[symbol]

where “ ” is the respective group operation defining the relationship between [symbol] and [symbol] .

More specifically, for abstract algebra, the term homomorphism may be a structure-preserving map between two algebraic structures such as groups, rings, or vector spaces. Isomorphisms, automorphisms, and endomorphisms are typically considered special types of homomorphisms. Among other more specific definitions of homomorphism, algebra homomorphism may be considered a homomorphism that preserves the algebra structure between two sets.

Multi-Party Computation (MPC) is a cryptographic technique that allows multiple parties to jointly compute a function over their private data without revealing it to each other. MPC works by using complex encryption to distribute computation between multiple parties. MPC enables parties to share data for computing tasks and obtain the output, but no party learns anything about others' data or secrets.

### SUMMARY OF THE INVENTION

An embodiment of the present invention may comprise a method for Multi-Party Computation (MPC) multiplication and division on a Multi-Party Computation (MPC) system of fixed-point data encoded in a domain of Farey rationals, the method comprising: encoding by a first data server computing device a first fixed-point number into a first encoded integer corresponding to the first fixed-point number as an encode function in the domain of Farey rationals; sending by the first data server computing device the first encoded integer to a third data server computing device; encoding by a second data server computing device a second fixed-point number into a second encoded integer corresponding to the second fixed-point number as the encode function in the domain of Farey rationals; sending by the second first data server computing device the second encoded integer to the third data server computing device; computing by the third data server computing device an arithmetic function, wherein the arithmetic function is chosen from a group comprised of multiplication and division, as part of the MPC system with the first encoded integer and the second encoded integer to obtain a result encoded integer wherein computation of the multiplication and division arithmetic functions of the MPC system further includes performing a FuzzyRound operation on the result encoded integer after performing the arithmetic function in accord with the MPC system functions to provide an approximation of a same precision for the result fixed-point number as for the 1^{st} and 2^{nd} fixed-point numbers; sending by the third data server computing device the result encoded integer to a fourth data server computing device; and decoding by the fourth data server computing device the result encoded integer into a result fixed-point number corresponding to the result encoded integer.

An embodiment of the present invention may further comprise a fixed-point encoding system for Multi-Party Computation (MPC) multiplication and division on a Multi-Party Computation (MPC) system of fixed-point data encoded in a domain of Farey rationals, the fixed-point encoding system comprising: a first data server computing device that encodes a first fixed-point number into a first encoded integer corresponding to the first fixed-point number as an encode function in the domain of Farey rationals and sends the first encoded integer to a third data server computing device; a second data server computing device that encodes a second fixed-point number into a second encoded integer corresponding to the second fixed-point number as the encode function in the domain of Farey rationals and sends the second encoded integer to the third data server computing device; the third data server computing device that computes an arithmetic function, wherein the arithmetic function is chosen from a group comprised of multiplication and division, as part of the MPC system with the first encoded integer and the second encoded integer to obtain a result encoded integer wherein computation of the multiplication and division arithmetic functions of the MPC system further includes performing a FuzzyRound operation on the result encoded integer after performing the arithmetic function in accord with the MPC system functions to provide an approximation of a same precision for the result fixed-point number as for the 1^{st} and 2^{nd} fixed-point numbers and that sends the result encoded integer to a fourth data server computing device; and the fourth data server computing device that decodes the result encoded integer into a result fixed-point number corresponding to the result encoded integer.

### BRIEF DESCRIPTION OF THE DRAWINGS

In the drawings,

FIG. 1 is a block diagram of the hardware implementation for an embodiment.

FIG. 2 is a flow chart of operations for an embodiment.

### DETAILED DESCRIPTION OF THE EMBODIMENTS

Secure multi-party computation (MPC) with rational data requires the data to be encoded—usually as elements of a ring or field—in a form that is compatible with the desired protocols. One such solution for working with rational-valued data, called Mercury, was introduced by Harmon and Delavignette. Their solution leverages a novel encoding technique from and pairs it with existing MPC protocols to allow efficient addition, subtraction, multiplication, and division. These protocols, though constant-round and exact, are somewhat limited in the number of computations they can perform, i.e., once the output of a computation overflows a pre-selected set of rationals, the result is incorrect. Building on their work, an embodiment introduces a probabilistic rounding protocol which, when paired with Mercury, yields constant-round protocols for addition, subtraction, multiplication, and division of fixed-point numbers for a dishonest minority of semi-honest parties. Protocols of an embodiment are compatible with both Additive and Shamir Secret Sharing, and an embodiment's fixed-point division significantly outperforms state-of-the-art protocols in terms of both round and communication complexity.

### 1 Introduction

In 1982, Yao introduced the millionaires' problem to the world. In this well-known problem Alice and Bob are two millionaires who are trying to determine which of them is wealthier without revealing their wealth. Through this problem and its solution Yao formally introduced secure computation. Secure computation allows the evaluation of functions on private data without revealing those data. A common technique for secure computation, and the focus of this paper, is Multi-Party Computation (MPC). In MPC, distrusting parties each with data want to evaluate a function on their data without revealing any information about the data other than the output of the function. Since Yao introduced the world to the millionaires problem in his pioneering paper, extensive amount of work has been done to extend his results, develop new MPC tools, and implement these tools in real world applications.

Multiple of these works on MPC depend on secret sharing for their protocols and their subsequent implementations. Secret sharing appeared a few years ahead of secure computation, it was introduced independently by Shamir and Blakley in 1979. Traditionally, in secret sharing each of parties receives a piece (share) of the private data (secret) being shared. Each of these shares being indistinguishable from a random value. Any authorized set of parties must have the ability to reconstruct the secret while unauthorized sets of parties should not be able to learn any information about the secret. When applied to secure computation the authorized sets can perform operations on the secrets and reconstruct them through communications with one another (e.g., sending/receiving shares, creating and sending new shares, etc.). In his seminal 1979 paper, Shamir introduced a technique to share secrets using polynomial interpolation over finite fields. Another well-known technique to share secrets is Additive Secret Sharing, which relies on the fact that a sum of uniformly random elements in a finite field is indistinguishable from uniformly random.

Since most MPC protocols are defined over finite rings or fields, such as the two previously mentioned, they require an encoder to transform the real data (often fixed-point or floating-point numbers) into elements of the ring (or field). Furthermore, since the objective of MPC is to compute functions, such as polynomial or rational functions, this encoder must be homomorphic with respect to the operations that compose the function, addition, multiplication, and division. There are two obvious solutions to encode real data, the first is to multiply fixed-point secret with digits after the radix point as the integer. The second one, for floating-point numbers, is to separately encode the sign, exponent, significand, and an extra bit that is 0 if and only if the number is 0.

Herein, we will focus on a different encoding. This encoder natively works with Farey rationals, rational numbers whose numerator and denominator are bounded in absolute value by an integer, and encodes them to a finite field. Originally, this scheme was intended for homomorphic encryption, though Harmon and Delavignette used it to create the Mercury protocols, for exact computation of addition, subtraction, multiplication, and division in constant communication rounds. A major drawback of their protocols are the limitations on the number of multiplications and divisions which can be performed due to the bounds on the numerator and denominator of the set of Farey rationals.

Following this research, we introduce FuzzyRound, a novel probabilistic rounding protocol that, when paired with Mercury, yields protocols for addition, subtraction, multiplication, and division of fixed-point numbers. Even though this adds a communication round to the exact protocols found in Mercury, it still maintains a low, constant number of communication rounds for all protocols while drastically increasing the depth of compatible circuits. Our approach also allows for fixed-point division by a public value with one round of communication.

Content herein is organized as follows.
Section 2 discusses notation and provides an overview of Shamir's scheme, additive secret sharing, and our complexity metrics.
Section 3 introduces Farey rationals and the encoder used to encode them as ring elements, as well as discussing fixed-point numbers.
Section 4 describes the building blocks which we use to build an embodiment's protocols. These include core protocols such as addition and multiplication, as well as shared random number generators and the constant-round division protocol of prior systems.
Section 5 discusses Mercury protocols.
Section 6 introduces our probabilistic rounding protocol, and then discusses the security and correctness of the protocol.
Section 7 introduces our fixed-point protocols, derives parameters which guarantee their correctness, and discusses an optimization which works with Shamir Secret Sharing.
Section 8 compares our protocols with prior work [4, 6, 22].
Section 9 provides conclusory remarks.

### 2 Notation and Preliminaries

For a positive integer denotes the ring of integers modulo [symbol] . In case is prime, we write [symbol] . The elements of will be represented by integers [symbol] . We use to denote that a randomized algorithm on input outputs [symbol] . If is deterministic, we simply write [symbol] . We use to mean that is selected uniformly at random from the set [symbol] . If a protocol has no argument, e.g., then the protocol takes no inputs.

### 2.1 Linear Secret Sharing Schemes (LSSS)

A sharing of among parties will be denoted [symbol] , so that the [symbol] ^{th} party receives the share [symbol] . mean that each party adds/subtracts or multiplies their share of with their share of [symbol] . We focus on two well-known and widely-used LSSS, though our protocols can be used with any schemes that work over and support addition and multiplication. Execution of LSSS protocols can be separated into the synchronous online phase, i.e. the operations which must be performed during the protocol, and the asynchronous offline phase. The offline phase is reserved for tasks that can be performed before the inputs to a particular function—or even the function itself are known. E.g., generating correlated randomness.

Shamir Secret Sharing (SSS). One creates Shamir shares of a secret [symbol] , where [symbol] , by generating a random polynomial of degree at most whose constant term is [symbol] (i.e.,) and whose remaining coefficients are chosen uniformly from [symbol] . Shares of are the field elements [symbol] . We assume the [symbol] ^{th} party receives the share [symbol] . Any collection of parties can pool their shares and reconstruct the polynomial using Lagrange interpolation, thereby obtaining the secret [symbol] .

Additive Secret Sharing (AddSS). An -additive sharing of a secret is a tuple [symbol] , where each and [symbol] . Each party receives one component of the tuple, and so the parties can collaborate to reconstruct by adding all of their shares.

Both SSS and AddSS support addition and multiplication of shared secrets. Addition can be performed locally—parties simply add their shares to obtain shares of the sum. Multiplication is more involved, and requires communication between parties. SSS multiplication can be done in 1 round using the protocol of Gennaro et al. AddSS multiplication uses so-called Beaver triples which are of the form, where and are unknown to all parties. The parties use to compute the product of shared secrets and by computing. This method requires 1 round of communication between the parties. Beaver triples are generated in the offline phase using somewhat homomorphic encryption or oblivious transfer.

### 2.2 Framework

We use-out-of-LSSS over for all protocols, in the case of AddSS we let. We assume that all parties are connected by pair-wise secure channels, these channels are used to send and receive shares as necessary. All adversaries are assumed to be semi-honest (honest-but-curious), and we tolerate at most of them. For SSS, we require to ensure the multiplication protocol works.

Complexity Metrics. We measure the complexity of a protocol in two ways. The first is communication complexity, which is the number of field elements sent between parties during the protocol. The second is round complexity, which is the number of sequential interactions required to execute the protocol, assuming interactions are executed in parallel when possible. An interaction starts when values are sent and ends when they are received.

### 2.3 Fixed-Point Numbers

Fixed-point numbers are rational numbers represented as a list of digits split by a radix point, and are defined by an integer (represented in a particular base) in a given range along with a fixed scaling factor (called the precision). For example, we can represent decimal numbers with integral part in the range and up to decimal places after the radix point as. We will represent a set of fixed-point numbers with parameters, where is the base, is the range of the integer part, and is the number of base-digits after the radix point. In particular, we define
the -bit fixed-point numbers with -bit bit precision.

### 3 Encoding Farey Rationals

As discussed in the introduction, our fixed-point protocols are based on existing protocols that use the Farey rationals. This section introduces the Farey rationals and the encoder used to map them into a finite field, along with some of their important properties.

### 3.1 Farey Rationals

The Farey rationals (also commonly called the Farey fractions and related to the Farey sequence) have been used in the context of rational approximations of irrational numbers, error-free computation, and the rational reconstruction problem. The latter asks when it is possible to recover an unknown fraction given a modulus which is co-prime to and the value. They are defined as the set
[symbol] ,
   where [symbol] , and are simply the set of reduced fractions with numerator and denominator both bounded in absolute value by [symbol] . Note that there may be many primes which yield the same set of Farey rationals. The following lemma collects some important properties of [symbol] .

Lemma 1. Let [symbol] be a prime and [symbol] .
(i) [symbol] .
(ii) [symbol] .
(iii) [symbol] .
(iv) [symbol] .

Proof. (i) [symbol] implies [symbol] , so [symbol] . (ii) Let [symbol] be nonzero. Then [symbol] and [symbol] , so [symbol] . (iii) If [symbol] , then clearly [symbol] . (iv) Since [symbol] is simply a set of rationals, it is not closed under the usual [symbol] . E.g. [symbol] , but [symbol] .

Observe that contains the fixed-point numbers as long as |·|

### 3.2 a Somewhat Homomorphic Encoding

In [17] Harmon et al defined a rational encoder for homomorphic encryption based on the aforementioned rational reconstruction problem. Their encoding maps elements of to the finite field [symbol] , and is defined by [symbol] . The decoding dec can be computed efficiently using a slight modification of the Extended Euclidean Algorithm. enc is somewhat homomorphic in the sense that it is homomorphic with respect to as long as the composition of operands remains in [symbol] . We summarize important properties of enc with the following lemma.

Lemma 2. Let [symbol] be a prime, [symbol] , and enc, dec be the encode and decode maps, respectively.
(i) If [symbol] then [symbol] .
(ii) enc is somewhat homomorphic w.r.t. addition and multiplication of Farey rationals. In particular, if [symbol] and [symbol] , then

[symbol]

Proof. (i) Let [symbol] . By definition, [symbol] . Of course, is a field element, and so depends on the representatives chosen for [symbol] . E.g., if we use [symbol] , then and [symbol] . (ii) Let [symbol] such that their sum and product remain in are co-prime with from the definition of the Farey rationals. Using the properties of congruences we obtain,
[symbol] , and

The result follows from the assumption that [symbol] .

### 4 Building Blocks

In this section, we briefly review some of the core protocols used by SSS and AddSS, as well as the constant-round protocols from and a protocol that creates shares of random-bit integers.

### 4.1 Core Protocols

These are protocols that are common to both SSS and AddSS, and are used liberally in our fixed-point protocols.

A secret is revealed using Output as follows: any parties send their share of to every other party so each party has at least shares (shares if using AddSS), then each party reconstructs locally. Mult is dependent on whether we use SSS or AddSS, as described in section 2.1. RandInt is realized using Pseudorandom Replicated Secret Sharing (PRSS) [7]. The remaining operations can be performed locally and are common to both SSS and AddSS. We hold off any further mention of communication complexity until section 7.2.

TABLE 1
Core protocols.

| | | |
|---|---|---|
| Operation | Purpose | Rounds |

| | |
|---|---|
| Reveal a secret | 1 |
| Add secret and public | 0 |
| Add secrets | 0 |
| Multiply secret and public | 0 |
| Multiply secrets | 1 |
| Shares of | 0 |

### 4.2 Shared Random Bits

Generating shares of random bits is a fundamental building block of many protocols. We detail below protocols for generating shares of a random bit (note, RandBit is not secure against malicious adversaries), and shares of a random-bit integer.

### Uniformly-Random Bit Protocol:

| Eq. 1 | RandBit | |
|---|---|---|
| | 1. | Two parties, say and , each select a uniform |
| | | ; |
| | 2. | for encodes , computes shares , and |
| | | distributes the shares among all parties; |
| | 3. | [b] = Mult([b₁], [b₂]); |
| | 4. | ; |
| | 5. | return . |

It is obvious that RandBit outputs a uniform random bit given each party uniformly selects −1 or 1, and therefore the product is equally as likely to be positive or negative. RandBit requires two rounds of communication—one for distributing shares of, and one for multiplication. We could also use the random bit protocol of [9], but it requires the same number rounds in addition to an exponentiation which may increase the runtime of generating many shared random bits if the field is large. Eq. 2 shows how to compute a uniformly random-bit integer. It requires invocations of RandBit executed in parallel, and, therefore, requires 2 rounds.

### Uniformly-Random-Bit Integer Protocol:

| Eq. 2 | RandInt | |
|---|---|---|
| | 1. | RandBit( ) ; |
| | 2. | , |
| | 3. | return . |

In all following protocols, RandBit and RandInt can be executed asynchronously in the offline phase; i.e. they do not contribute to the online complexity.

### 5 Mercury: Protocols for

We briefly review the protocols for addition, subtraction, multiplication, and division of Farey rationals using SSS or AddSS. These protocols are obtained by attaching the encoder in section 3.2 and (in the case of division) composing some existing protocols.

Prior protocols rely heavily on Lemma 1. In particular, subtraction uses lemma 1(i) and division uses lemma 1(ii). These two properties allow them to perform in the usual way—addition with a negative, and multiplication with a reciprocal. All of their protocols are constrained by the fact that is not closed under. This means that in practice they must take the domain of secrets to be a subset that is chosen so that any desired compositions of elements of remain in. The choice of depends on the secrets, and the functions that must be computed on the shared secrets. We discuss this subset further in Section 5.2.

### 5.1 the Protocols

Addition, subtraction, and multiplication are simple—do the desired operation on the shares of the encoded secrets. The division protocol is slightly more complex, so we describe it below in Eq. 3 for completeness.

### Mercury Division Protocol of [16]:

| Eq. 3 | Div | |
|---|---|---|
| | | Let e₀ =enc(x₀/y₀) and e₁ =enc(x₁/y₁). |
| | 1. | [r] RandInt( ); |
| | 2. | [re₁] = Mult([r], [e₁]); |
| | 3. | re₁ = Output([re₁]); |
| | 4. | calculate r⁻¹e₁⁻¹ = (re₁)⁻¹; |
| | 5. | [e₁⁻¹] = r⁻¹e₁⁻¹ [r]; |
| | 6. | [e₀e₁⁻¹] = Mult([e₀], [e₁⁻¹]); |
| | 7. | return [e₀e₁⁻¹] = [enc(x₀y₁/y₀x₁)]. |

The addition and subtraction protocols can be performed locally, and so have round complexity 0. Multiplication requires 1 round, and division requires 3 rounds—2 for the invocations of Mult and 1 for the invocation of Output. Notice that multiplication and division by a public integer can be performed locally. Suppose we want to multiply or divide a shared secret by a nonzero integer [symbol] . The multiplication is straight forward and corresponds to the “Multiply secret and public” protocol in Table 1—simply multiply each share by the public value [symbol] . Division is similar—use the same protocol but instead multiply by [symbol] . The result is correct, as long as the product/quotient remains in [symbol] .

### 5.2 Limitations of Mercury

Circuit Depth. In [16, section 4.2], the authors discuss how exactly to choose the aforementioned subset so that compositions of elements of remain in [symbol] . They do this by viewing an arithmetic circuit as the multivariate polynomial it computes, and then obtaining bounds on the norm and total degree of the polynomial. Using these bounds, they show that for and (one should view this set as 32 bit fixed-point numbers with 14 bit precision), one can perform up to 14 multiplications and 2³³⁴ additions, or 21 multiplications and 2¹² additions before the output may overflow [symbol] . With respect to division, they mention that the derived bounds on circuit depth do not apply in general because the denominator of a quotient of two elements of [symbol] need not have denominator of the form [symbol] , which greatly reduces the number of subsequent operations (especially additions) that can be performed. No solution to this limitation is proposed, and the authors simply state that divisions should always be done as late as possible to avoid overflowing [symbol] .

Data Types. Although the authors of [16] do not suggest a data type for which Mercury is well-suited, it seems clear to us that the type they had in mind is the rational data type (e.g. math/big package in Go and Fraction class in Python), in which fractions are represented as a ratio of two integers. This type requires frequent invocations of god to ensure fractions are reduced and/or a large amount of memory to store the numerator and denominator. All of the Mercury protocols work well with this data type since they use the Farey rationals.

Mercury is only partly compatible with fixed-point arithmetic in the sense that only addition and subtraction are guaranteed to work. This is because it does not come equipped with a truncation protocol that can deal with the precision changes that arise from products and quotients of fixed-point numbers. For example, consider the fixed-point numbers. If we add or subtract two elements, the precision remains. If we multiply or divide two elements, the precision doubles to 2 or we get a fraction whose denominator may not be a power of 2. This means that, in practice, the hardware must truncate to bits which may yield incorrect results.

### 6 A Probabilistic Rounding Protocol

In this section, we introduce a rounding protocol which, when paired with Mercury, yields protocols for fixed-point arithmetic using the Farey rationals. In particular, it allows one to “normalize” the product or quotient of two fixed-point numbers to obtain an approximation with the same precision. It also increases the depth of circuits that the Mercury protocols can evaluate, which, of course, comes at the price of exactness.

The example below illustrates the idea of the protocol by performing the truncation on un-shared values.

Example 1. Given, suppose we want to truncate to four decimal places of precision. On un-shared values, the protocol proceeds as follows:
(i) Secret to be truncated: 3.14159265;
(ii) Scale secret by 10⁸/10⁴=10⁴:31415.9265;
(iii) Generate random integer masks r, s: say r=537914 and s=7116;
(iv) Add r+10⁻⁴ s to the scaled secret: 31415.9265+537914.7116=569330.6381;
(v) Round down to the nearest integer: [569330.6381]=569330;
(vi) Subtract r from the rounded value: 569330−537914=31416;
(vii) Scale result by 10⁻⁴:31416·10⁻⁴=3.1416.

This yields 31416/10⁴≈314159265/10⁸, as desired. Notice that 314159265/10⁸−31416/10⁴=9265/10⁸<10⁴/10⁸=1/10⁴.

FuzzyRound approximates for some positive integer base and nonnegative integer [symbol] . We assume that at the start of the protocol each party has: [symbol] , and shares of [symbol] . For notational simplicity, we will write instead of [symbol] .

### The Probabilistic Rounding Protocol:

| Eq. 4 | FuzzyRound | |
|---|---|---|
| | Constraints: , And if , | |
| | then . | |
| | 1. | RandIntRandInt |
| | 2. | |
| | 3. | |
| | 4. | encOutput( ); |
| | 5. | enc; |
| | 6. | compute |
| | 7. | ; |
| | 8. | ; |
| | 9. | return |

The constraint is required for the proof of security (Theorem 2), and ensures that computations do not overflow during the execution of FuzzyRound. The latter constraint will be used to obtain parameters for fixed-point arithmetic in Section 7.1.

Observe that FuzzyRound probabilistically rounds up or down, depending on the values of [symbol] . In particular, it rounds down whenever remains between [symbol] and [symbol] . Proposition 1 provides details.

Proposition 1. Let be the fractional part of [symbol] . Then FuzzyRound
(i) rounds down with probability, and
(ii) and rounds up with probability.

Proof. Recall that the bit from step (6) of Eq. 4. Clearly FuzzyRound rounds down if and only if [symbol] [symbol]
and eq. (1) holds precisely when [symbol] . Note that if divides [symbol] , then and [symbol] . Suppose, whence [symbol] . Then eq. (1) implies [symbol] [symbol]
Since is selected from the uniform distribution over [symbol] , it follows that [symbol] and [symbol] .

This completes the proof.

### 6.1 Correctness and Security

Theorem 1 (Correctness). The truncation protocol FuzzyRound is correct in the semi-honest security model. In particular, if all parties follow the protocol faithfully, for input and output [symbol] , then

[symbol]

Proof. For

[symbol]

This completes the proof.

Theorem 2 (Semi-honest Security). The truncation protocol FuzzyRound is semi-honest secure in the sense that the parties do not learn anything beyond what they can efficiently compute from their respective inputs and outputs.

Proof. Let be a semi-honest adversary that corrupts at most parties. We will show that there is polynomial-time simulator that can simulate the real-world view of [symbol] . We assume that has oracle access to RandInt(·).

If corrupts any parties, then it obtains shares, along with values that can be computed from these shares and the public values. By the security of the underlying secret-sharing scheme, the shares are indistinguishable from random. Additionally, has the public value [symbol] . We now show that can generate a value which is statistically indistinguishable from [symbol] .

Let an integer base, and the desired base-precision after truncation. Suppose [symbol] , and [symbol] , where [symbol] is a statistical security parameter.

We start by showing that is uniform over its range. It suffices to show that the random variable is uniform. Note that can perfectly simulate since it knows and has oracle access to RandInt(·).

If [symbol] , then [symbol] . Since [symbol] , and [symbol] . This means the distribution of is uniform, whence the distribution of is also uniform. That is, since [symbol] and [symbol] ,

[symbol]

Let be the random variable obtained by shifting the distribution of by—to the left if and to the right if [symbol] . Without loss of generality, suppose [symbol] . With this shift in mind, we split into three subintervals: [symbol] , [symbol] , and [symbol] .

It is clear that
(i) [symbol] ,
(ii) [symbol] , and
(iii) [symbol] .

We now show that the statistical distance between and is bounded by a negligible function of the statistical security parameter.
[symbol] So [symbol] , which is negligible in [symbol] , as desired.

Complexity. FuzzyRound requires two invocations of RandInt and one invocation of Output. Since the random integers can be generated in parallel and asynchronously, the round complexity of FuzzyRound is 2 offline and 1 online.

### 7 Fixed-Point Protocols Over

Our fixed-point arithmetic protocols are obtained by pairing the rational arithmetic protocols of Harmon and Delavignette (Section 5.1) with FuzzyRound. The online round and communication complexities of the protocols are summarized in Table 2.

Take the domain of secrets to be the fixed-point numbers [symbol] , and let [symbol] .

Addition and Subtraction. The sum and difference of are contained in as long as [symbol] . This means that fixed-point addition and subtraction can be performed locally as [symbol] .

Multiplication and Division. These operations each require one invocation of FuzzyRound( ) and one invocation of Mult or Div.

### Fixed-Point Multiplication Protocol:

| Eq. 5 | FxpMult | |
|---|---|---|
| | 1. | Mult; |
| | 2. | FuzzyRound; |
| | 3. | return . |

Since FuzzyRound is probabilistic, the outputs of FxpMult and FxpDiv can be off by up to one bit (a trait shared with [4]). This is not a problem since fixed-point operations are inherently approximate, and the user can mitigate the issue by judiciously increasing the fixed-point precision.

As addition and subtraction are local, we do not discuss them further. Instead, we spend the remainder of the paper discussing multiplication and division—mainly division.

### Fixed-Point Division Protocol:

| Eq. 6 | FxpDiv | |
|---|---|---|
| | 1. | Div; |
| | 2. | FuzzyRound; |
| | 3. | return . |

TABLE 2
Online complexity of fixed-point multiplication
and division. Communication is measured in
field elements sent by all parties.

| | | |
|---|---|---|
| Operation | Online Comm. | Online rounds |

| | |
|---|---|
| | 0 |
| FxpMult | |
| FxpDiv | |

### 7.1 Parameters

Let and be integers such that [symbol] and [symbol] . Recall that FuzzyRound works correctly and is secure as long as [symbol] , and [symbol] . We use these constraints to provide examples of and for which our fixed-point protocols work. In particular, we must find large enough so that: (i) [symbol] , (ii) the product and quotient of any two elements in remains in [symbol] , and (iii) FuzzyRound is correct on inputs that are a product or quotient of any two elements of [symbol] .

For simplicity, we pick [symbol] and [symbol] . If and [symbol] , then and [symbol] . It follows from above constraints that we may take [symbol] . Equivalently, since [symbol] .

TABLE 3
Parameters that enable fixed-point multiplication
and division with and security parameter.

| | | | | | |
|---|---|---|---|---|---|
| Bit-size of integer part | 8 | 16 | 32 | 32 | 64 |
| Bit-size of fractional part | 8 | 16 | 16 | 32 | 32 |
| Size of field | 177 | 289 | 353 | 513 | 641 |

### 7.2 an SSS Division Optimization

When using the division protocol with Shamir's scheme parties are required to perform the 2 invocations of Mult. Since the product of the first multiplication, the randomly masked divisor, is reconstructed immediately, it is possible to use a simplified version of multiplication. This simplified version only requires each party to multiply their shares locally, and avoids any communications within the protocol. This simplified multiplication increases the number of shares needed for reconstruction of the product from to [symbol] . However, since the division is already using shares, this saves a round of communication by avoiding the round of communication required in the first invocation of Mult to maintain the original threshold.

By using this optimization, we can reduce the online rounds of communication for division from 3 to 2, one invocation for Output and one invocation of Mult, without increasing communication complexity or the number of offline communications. We will use this optimization henceforth.

### 8 Comparison with Prior Work

The first comparison and most similar protocols for multiplication and division of fixed-point numbers were introduced by Catrina and Saxena. The suggested division protocol takes advantage of Goldshmidt's method, and SSS in a semi-honest security model. A variant of their division protocol is used for fixed-point division in MP-SPDZ. Catrina further improved the round and communication complexities of the protocols. Table 4 compares the online round and communication complexities of protocols of an embodiment with those of Catrina.

TABLE 4
Complexity comparison between our work and that of Catrina. Both the
online and offline communication complexity are measured in elements
of sent among all parties throughout a protocol. and are the number
of parties and the threshold, resp., is the number of iterations of
Goldschmidt's method, and is the fixed-point precision.
Using SSS + optimization of section [7.2]

| | | |
|---|---|---|
| Protocol | Rounds | Online Comm. |

| | | |
|---|---|---|
| Our work | FxpMult | 2 |
| | FxpDiv | 3 |
| [4] | FXMul | 2 |
| | FXDiv | |

Using the fixed-point numbers along with the encoding defined, the protocols of Catrina et al require, where is a security parameter. Our protocols, on the other hand, require a larger field. With the same set of fixed-point numbers, we need. So, for example, if we want to use the fixed-point numbers with, then we need or larger. In contrast, Catrina et al can get away with.

Although limited to integer division, another interesting protocol was introduced by Veugen and Abspoel. They present two division variations, a public divisor protocol and a private divisor protocol where only one party knows the divisor. Even though our division protocol uses rationals in general, comparison makes sense because we can simply restrict the inputs to FxpDiv to be integers of appropriate size. Veugen et al use MP-SPDZ to compare the performance of their two protocols with two built-in primitives that are based on the aforementioned work of Catrina et al. They use 3 parties, and provide runtimes along with communication complexities (in MB) for dividing a 2-bit integer by an -bit integer. We will compare our (estimated) communication complexity with these two benchmarks. The framework used by Veugen et al. shares integers over the ring with not-necessarily-prime. Of course, if SSS is being used, then will be prime. Henceforth, we will refer to this as the secret sharing modulus.

First, we compare the size of the secret sharing modulus required for the protocols. Since the setting is slightly different-we are only dividing integers—we can get away with [symbol] . Veugen et al require, and the MP-SPDZ primitive requires [symbol] .

TABLE 5
Size of secret sharing modulus for
integer division with -bit dividend
and -bit divisor, and security parameter.

| | | | | | | | | |
|---|---|---|---|---|---|---|---|---|
| Us | 4 | 117 | 8 | 149 | 16 | 213 | 32 | 341 |
| [22] | 4 | 97 | 8 | 113 | 16 | 145 | 32 | 209 |
| [6] | 4 | 57 | 8 | 73 | 16 | 105 | 32 | 169 |

Even though our protocol FxpDiv requires a noticeably larger secret-sharing modulus than its competitors, Table 6 shows that it still requires far less communication. We emphasize that our numbers in this comparison were estimated using both the modulus sizes given in Table 5 and the total (online+offline) communication complexity (in field elements) of FxpDiv: [symbol] . Additionally, our estimation is based on FxpDiv with SSS with [symbol] , [symbol] , whereas the our competitors are based on AddSS (in particular, Replicated Secret Sharing) in MP-SPDZ. Point is, the fact that we do not have an implementation of FxpDiv means this comparison should be taken with caution.

TABLE 6
Total communication complexity in megabytes (MB) for dividing a
2f bit integer by an f -bit integer. Our division protocol (applied
to integers) vs. the private divisor integer division protocol of [22]
and the secret divisor protocol of MP-SPDZ based on [6].
The last two rows are lifted from [22, table 1].

| | | | |
|---|---|---|---|
| 4 | 8 | 16 | 32 |

Us
(private)
(secret)

Veugen et al also discuss how their private integer division protocol can be modified slightly to obtain a public integer division protocol. Benchmarks suggest that their public divisor protocol outperforms the native solution of MPSPDZ for 2-bit dividend and -bit divisor when [symbol] . For example, when the protocol of Veugen et al. requires 20 MB of communication, in contrast to the native protocol which requires 33.6 MB. We can do much better. Using the “division by a public integer” protocol described at the end of Section 5.1 along with FuzzyRound, we can divide a secret 32-bit integer by a public 16-bit integer and truncate to ensure the result is in [symbol] . This takes 1 online round and 2 offline rounds, and has total communication [symbol] , with the communication complexity being dominated by the offline communication. As in the preceding comparison, we use SSS with [symbol] , [symbol] .

The final comparison is against the Mercury protocols. As our protocols are built upon these by adding one online round of communication and two offline rounds via composition with FuzzyRound, it is clear that they have more attractive communication and round complexity. Though as discussed in Section 5.2, the Mercury protocols are strongly limited by their circuit depth and their reliance on rationals instead of fixed-point numbers. This allows our protocols to be more versatile in their applications by removing the main two limitations.

### 9 Conclusion

The various embodiments have introduced new constant-round protocols for addition, subtraction, multiplication, and division of shared fixed-point numbers that work with both Additive Secret Sharing and Shamir Secret Sharing in the honest majority setting where any adversaries are semi-honest. These new protocols are enabled by composing the protocols introduced in of earlier work with a novel probabilistic rounding protocol that we call FuzzyRound. Our fixed-point division protocol, in particular, enjoys significantly lower communication complexity than earlier work.

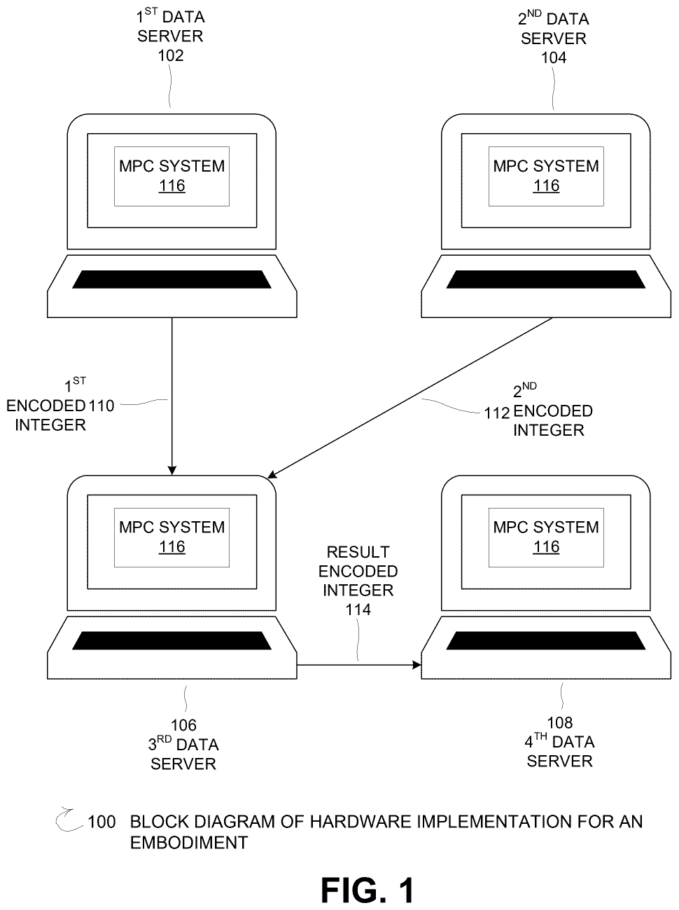

### Hardware Implementation for an Embodiment (FIG. 1)

FIG. 1 is a block diagram 100 of the hardware implementation for an embodiment. A 1^{st} data server computing device 102 is connected over an electronic network/bus connection 110 to 3^{rd} data server computing device 106. A 2^{nd} data server computing device 104 is also connected over an electronic network/bus connection 112 to the 3^{rd} data server computing device 106. The third data server computing device 106 is further connected over an electronic network/bus connection 114 to the 4^{th} data server computing device 108.

In the embodiment shown in FIG. 1, the 1^{st} data server computing device 102 acts as the source of the 1^{st} encoded integer 110 and the 1^{st} data server computing device 102 sends the 1^{st} encoded integer 110 over the network/bus connection 110 to the 3^{rd} data server computing device 106. The 2^{nd} data server computing device 104 acts as the source of the 2^{nd} encoded integer 112 and the 2^{nd} data server computing device 104 sends the 2^{nd} encoded integer 112 over the network/bus connection 112 to the 3^{rd} data server computing device 106.

The 3^{rd} data server computing device 106, in compliance with the MPC system 116, performs an arithmetic operation (addition, subtraction, multiplication, and/or division) with the 1^{st} encoded integer 110 and the 2^{nd} encoded integer 112. The encoded integers are encoding fixed-point values. Accordingly, only division and multiplication operations are subject to the need for the FuzzyRound protocol of the various embodiments as multiplication and division can change the precision of a fixed-point arithmetic result. The FuzzyRound operation provides an approximation of a same precision as the first and second fixed-point numbers of the arithmetic operation. The FuzzyRound operation further incorporates the RandInt operation, which then still further incorporates the RandBit operation. The 3^{rd} data server computing device 106 then sends the result encoded integer 114 over the network/bus connection 114 to the 4^{th} data server computing device 108. The 4^{th} data server computing device 108 then decodes the result encoded integer 114 into a result fixed-point number.

The 1^{st} encoded integer 110 and the 2^{nd} encoded integer 112 starts at the source computing device as one or more rational numbers in fixed-point format. An embodiment at the 1^{st} data server computing device 102 and the 2^{nd} data server computing device 104 encodes the fixed-point numbers into corresponding 1^{st} encoded integer 110 and the 2^{nd} encoded integer 112, respectively as a function of in the domain of Farey rationals.

Generally, communications, including concealed/encrypted communications, are bi-directional and may be connected between any of the data server computing devices 102-108, such that data server computing devices 102-108 may change roles as is necessary to accommodate the transfer of data back and forth between the data server computing devices 102-108. Additionally, while the data server computing devices 102-108 are depicted as separate devices in FIG. 1, the functionality of the data server computing devices 102-108 may be shared on a single computing system/device or among two or more computing devices.

Further, as shown in FIG. 1, the data server computing devices 102-108 appear to be laptop computers, but any computing device or system may be satisfactory. Generally, any computing device capable of communication over any form of electronic network or bus communication platform may be one or more of the data server computing devices 102-108. Additionally, data server computing devices 102-108 may actually be the same physical computing device communicating over an internal bus connection with itself.

Various embodiments may implement the network/bus communications channel 110-114 using any communications channel 110-114 capable of transferring electronic data between the data server computing devices 102-108. For instance, the network/bus communication connection 110-114 may be an Internet connection routed over one or more different communications channels. Likewise, the network/bus communication connection 110-114 may be an internal communications bus of a computing device, or even the internal bus of a processing or memory storage Integrated Circuit (IC) chip, such as a memory chip or a Central Processing Unit (CPU) chip. The network/bus communication channel 110-114 may utilize any medium capable of transmitting electronic data communications, including, but not limited to: wired communications, wireless electro-magnetic communications, fiber-optic cable communications, light/laser communications, sonic/sound communications, etc., and any combination thereof of the various communication channels.

The various embodiments may provide the control and management functions detailed herein via an application operating on the data server computing devices 102-108. The data server computing devices 102-108 may each be a computer or computer system, or any other electronic devices capable of performing the communications and computations of an embodiment. The data server computing devices 102-108 may include, but are not limited to: a general-purpose computer, a laptop/portable computer, a tablet device, a smart phone, an industrial control computer, a data storage system controller, a CPU, a Graphical Processing Unit (GPU), an Application Specific Integrated Circuit (ASIC), and/or a Field Programmable Gate Array (FPGA). Notably, the data server computing devices 102-108 may be the storage controller of a data storage media (e.g., the controller for a hard disk drive). Embodiments may be provided as a computer program product which may include a computer-readable, or machine-readable, medium having stored thereon instructions which may be used to program/operate a computer (or other electronic devices) or computer system to perform a process or processes in accordance with the various embodiments. The computer-readable medium may include, but is not limited to, hard disk drives, floppy diskettes, optical disks, Compact Disc Read-Only Memories (CD-ROMs), Digital Versatile Disc ROMS (DVD-ROMs), Universal Serial Bus (USB) memory sticks, magneto-optical disks, ROMs, random access memories (RAMs), Erasable Programmable ROMs (EPROMs), Electrically Erasable Programmable ROMs (EEPROMs), magnetic optical cards, flash memory, or other types of media/machine-readable medium suitable for storing electronic instructions. The computer program instructions may reside and operate on a single computer/electronic device or various portions may be spread over multiple computers/devices that comprise a computer system. Moreover, embodiments may also be downloaded as a computer program product, wherein the program may be transferred from a remote computer to a requesting computer by way of data signals embodied in a carrier wave or other propagation medium via a communication link (e.g., a modem or network connection, including both wired/cabled and wireless connections).

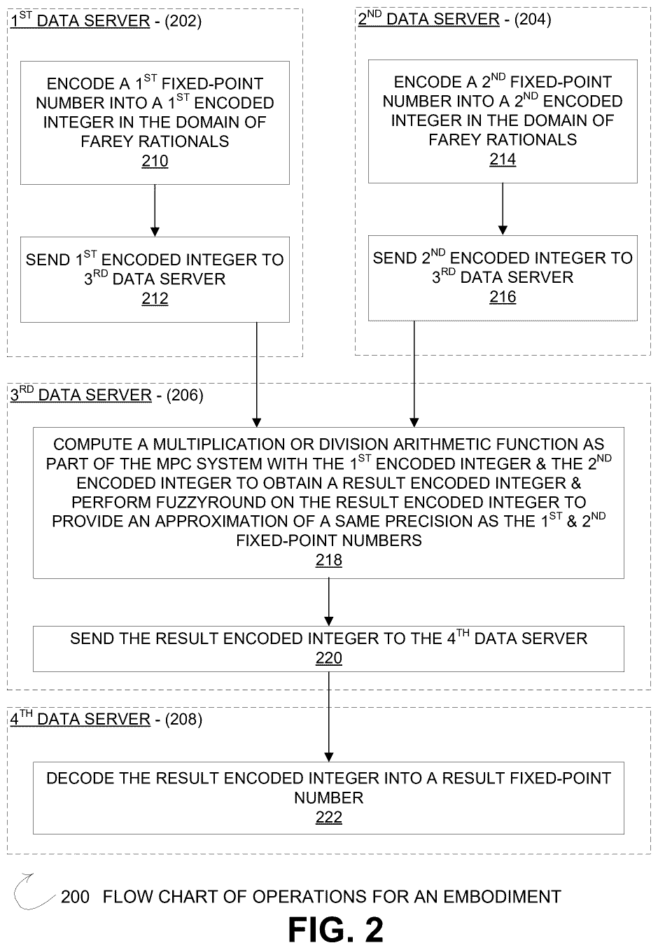

### Operational Flow Chart for an Embodiment (FIG. 2)

FIG. 2 is a flow chart 200 of operations for an embodiment. At process 210, the 1^{st} data server computing device 202 encodes a 1^{st} fixed-point number into a 1^{st} corresponding encoded integer in the domain of Farey rationals. At process 212, the 1^{st} data server computing device 202 sends the 1^{st} encoded integer to the 3^{rd} data server computing device 206. At process 214, the 2^{nd} data server computing device 204 encodes a 2^{nd} fixed-point number into a 2^{nd} corresponding encoded integer in the domain of Farey rationals. At process 216, the 1^{st} data server computing device 202 sends the 1^{st} encoded integer to the 3^{rd} data server computing device 206. At process 218, the 3^{rd} data server computing device 206, in accord with the MPC system, computes an arithmetic function with the 1^{st} encoded integer and 2^{nd} encoded integer in to obtain at least one result encoded integer. The potential arithmetic functions are one or more of addition, subtraction, multiplication, and division. For the various embodiments, only division and multiplication operations are subject to the need for the FuzzyRound protocol of the various embodiments as multiplication and division can change the precision of a fixed-point arithmetic result. The FuzzyRound operation provides an approximation of a same precision as the first and second fixed-point numbers of the arithmetic operation. The FuzzyRound operation further incorporates the RandInt operation, which then still further incorporates the RandBit operation.

At process 220, the 3^{rd} data server computing device 206 sends the result encoded integer to the 4^{th} data server computing device 208. At process 222, the 4^{th} data server computing device decodes the result encoded integer into a corresponding result fixed-point number. The MPC system running on the data server computing devices 202-208 should be of the same type.

Additionally, while the flow charts and flow chart details described above with respect to FIG. 2 describe a methodology that may be embodied as a method or process, another embodiment may be recognized as a computer system, and/or as an intermediary computing device that stores and/or performs homomorphic operations of encrypted data by implementing the processes described above with respect to the flow chart and flow chart details of FIG. 2. Further, in describing the computing system, and/or the intermediary computing system, one, or more, individual processes described above for the methodology may be broken down and represented as a subsystem of the overall encryption computer system. A subsystem of the computer system, in whole or in part, may be assigned to a particular hardware implemented system, such as a dedicated Application Specific Integrated Circuit (ASIC) or Field Programmable Gate Array (FPGA). One or more subsystems, in whole or in part, may alternatively be implemented as software or firmware instructions defining the operation of a computer system with specific regard to the one or more subsystems implemented as software or firmware instructions. The software or firmware instructions may cause the Central Processing Unit, memory, and/or other systems of a computer system to operate in particular accordance with the particular one or more subsystems designated features.

The foregoing description of the invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated.

What is claimed is:

1. A method for Multi-Party Computation (MPC) multiplication and division on a Multi-Party Computation (MPC) system of fixed-point data encoded in a domain of Farey rationals, the method comprising:
encoding by a first data server computing device a first fixed-point number into a first encoded integer corresponding to said first fixed-point number as an encode function in said domain of Farey rationals;
sending by said first data server computing device said first encoded integer to a third data server computing device;
encoding by a second data server computing device a second fixed-point number into a second encoded integer corresponding to said second fixed-point number as said encode function in said domain of Farey rationals;
sending by said second first data server computing device said second encoded integer to said third data server computing device;
computing by said third data server computing device an arithmetic function, wherein said arithmetic function is chosen from a group comprised of multiplication and division, as part of said MPC system with said first encoded integer and said second encoded integer to obtain a result encoded integer wherein computation of said multiplication and division arithmetic functions of said MPC system further includes performing a FuzzyRound operation on said result encoded integer after performing said arithmetic function in accord with said MPC system functions to provide an approximation of a same precision for said result fixed-point number as for said 1^{st} and 2^{nd} fixed-point numbers;
sending by said third data server computing device said result encoded integer to a fourth data server computing device; and
decoding by said fourth data server computing device said result encoded integer into a result fixed-point number corresponding to said result encoded integer.

2. The method of claim 1 wherein said FuzzyRound operation is a rounding protocol which normalizes said result encoded integer output from said arithmetic operation as a function of said first encoded integer of said first fixed-point number and said second encoded integer of said second fixed-point number and obtains an approximation with precision matching that of said first fixed first point number and said second fixed-point number.

3. The method of claim 2 wherein said FuzzyRound operation incorporates a RandInt operation.

4. The method of claim 3 wherein said RandInt operation outputs a k bit random integer via k iterations of RandBit operation.

5. The method of claim 4 wherein said k iterations of said RandBit operation are performed in parallel.

6. The method of claim 4 wherein said RandBit operation outputs a uniform random bit as a function of two input selections of 1 or −1.

7. The method of claim 4 wherein said RandInt and said RandBit operations are performed asynchronously in an offline phase such that said RandInt and said RandBit operations do not contribute to online complexity.

8. A fixed-point encoding system for Multi-Party Computation (MPC) multiplication and division on a Multi-Party Computation (MPC) system of fixed-point data encoded in a domain of Farey rationals, the fixed-point encoding system comprising:
a first data server computing device that encodes a first fixed-point number into a first encoded integer corresponding to said first fixed-point number as an encode function in said domain of Farey rationals and sends said first encoded integer to a third data server computing device;
a second data server computing device that encodes a second fixed-point number into a second encoded integer corresponding to said second fixed-point number as said encode function in said domain of Farey rationals and sends said second encoded integer to said third data server computing device;
said third data server computing device that computes an arithmetic function, wherein said arithmetic function is chosen from a group comprised of multiplication and division, as part of said MPC system with said first encoded integer and said second encoded integer to obtain a result encoded integer wherein computation of said multiplication and division arithmetic functions of said MPC system further includes performing a FuzzyRound operation on said result encoded integer after performing said arithmetic function in accord with said MPC system functions to provide an approximation of a same precision for said result fixed-point number as for said 1^{st} and 2^{nd} fixed-point numbers and that sends said result encoded integer to a fourth data server computing device; and
said fourth data server computing device that decodes said result encoded integer into a result fixed-point number corresponding to said result encoded integer.

9. The fixed-point encoding system of claim 8 wherein said FuzzyRound operation is a rounding protocol which normalizes said result encoded integer output from said arithmetic operation as a function of said first encoded integer of said first fixed-point number and said second encoded integer of said second fixed-point number and obtains an approximation with precision matching that of said first fixed first point number and said second fixed-point number.

10. The fixed-point encoding system of claim 9 wherein said FuzzyRound operation incorporates a RandInt operation.

11. The fixed-point encoding system of claim 10 wherein said RandInt operation outputs a k bit random integer via k iterations of RandBit operation.

12. The fixed-point encoding system of claim 11 wherein said k iterations of said RandBit operation are performed in parallel.

13. The method of claim 4 wherein said RandBit operation outputs a uniform random bit as a function of two input selections of 1 or −1.

14. The method of claim 4 wherein said RandInt and said RandBit operations are performed asynchronously in an offline phase such that said RandInt and said RandBit operations do not contribute to online complexity.
